(19) United States
(12) Patent Application Publication
(10) Pub. No.: US 2026/0219614 A1
(43) Pub. Date: Jul. 30, 2026

(54) FIXING DEVICE AND IMAGE FORMING APPARATUS

(71) Applicant: FUJIFILM Business Innovation Corp., Tokyo (JP)

(72) Inventors: Tomotake INAGAKI, Kanagawa (JP); Hideaki OHARA, Kanagawa (JP); Kenji OMORI, Kanagawa (JP); Toshiyuki MIYATA, Kanagawa (JP); Yasutaka GOTOH, Kanagawa (JP); Masayuki SEKO, Kanagawa (JP); Yasuhiko KINUTA, Kanagawa (JP); Hitoshi KOMURO, Kanagawa (JP)

(73) Assignee: FUJIFILM Business Innovation Corp., Tokyo (JP)

(21) Appl. No.: 19/426,103

(22) Filed: Dec. 19, 2025

(30) Foreign Application Priority Data
Jan. 24, 2025 (JP) 2025-010977

(51) Int. Cl. G03G 15/20; H05B 6/10

(52) U.S. Cl. CPC G03G 15/2057; G03G 15/2064; H05B 6/105; G03G 2215/2035; G03G 2215/2048

(57) ABSTRACT

A fixing device includes a heating belt having a metal layer and a surface layer provided on the metal layer, a pressurizing roll that comes into contact with the heating belt and that pressurizes the heating belt, and a heating device that heats the heating belt at a position other than a contact portion between the heating belt and the pressurizing roll, in which the surface layer of the heating belt contains a polysiloxane compound having a T unit represented by a formula: [R¹SiO_{3/2}]ₘ (in the formula, R¹ is an organic group, m is an integer of 2 or more, and at least one R¹ in the T unit is a group including at least one of an alkyl group or an aryl group).

### CROSS-REFERENCE TO RELATED APPLICATIONS

This application is based on and claims priority under 35 USC 119 from Japanese Patent Application No. 2025-010977 filed Jan. 24, 2025.

### BACKGROUND

### (i) Technical Field

The present invention relates to a fixing device and an image forming apparatus.

### (ii) Related Art

In an image forming apparatus (such as a copy machine, a facsimile machine, and a printer) using an electrophotographic method, a toner image formed on a surface of an image holder is transferred to the surface of a recording medium and fixed on the recording medium such that an image is formed.

For example, JP4635783B discloses “fixing device including a heating member having a conductive layer, a pressure member that forms a fixing nip portion by pressure-contacting the heating member, and a heating unit that induction-heats the heating member through the conductive layer”.

JP6131707B discloses “fixing device including a fixing member, a heat source, a pressure member, a nip forming member that is disposed on an inner peripheral side of the fixing member and that forms a nip in opposition to the pressure member, and a shielding member that is disposed between the fixing member and the heat source and that shields the heat source”.

### SUMMARY

As the fixing device, a fixing device including a heating belt having a metal layer and a surface layer provided on the metal layer, a pressurizing roll that comes into contact with the heating belt and that pressurizes the heating belt, and a heating device that heats the heating belt at a position other than a contact portion between the heating belt and the pressurizing roll is known. Hereinafter, the fixing device is also referred to as “specific fixing device”.

Aspects of non-limiting embodiments of the present disclosure relate to a fixing device in which, in the specific fixing device, release properties of the heating belt are high and occurrence of unevenness in image glossiness caused by wrinkles of the surface layer of the heating belt is suppressed as compared with a case where the surface layer of the heating belt is a fluororesin layer.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Methods for achieving the above object include the following aspects.

According to an of the present disclosure, there is provided a fixing device including:
a heating belt having a metal layer and a surface layer provided on the metal layer;
a pressurizing roll that comes in contact with the heating belt and that pressurizes the heating belt; and
a heating device that heats the heating belt at a position other than a contact portion between the heating belt and the pressurizing roll,
in which the surface layer of the heating belt contains a polysiloxane compound having a T unit represented by a formula: [R¹SiO_{3/2}]ₘ (in the formula, R¹ is an organic group, m is an integer of 2 or more, and at least one R¹ in the T unit is a group including at least one of an alkyl group or an aryl group).

### BRIEF DESCRIPTION OF THE DRAWINGS

Exemplary embodiment(s) of the present invention will be described in detail based on the following figures, wherein:

FIG. 1 is a view schematically showing an example of a fixing device according to a first exemplary embodiment, in which a fixing device is in a state in which a pressurizing roll is positioned at a spaced position;

FIG. 2 is a view schematically showing an example of the fixing device according to the first exemplary embodiment, in which the fixing device is in a state in which the pressurizing roll is positioned at a pressurized position;

FIG. 3 is a view schematically showing a configuration of an example of a fixing device according to a second exemplary embodiment;

FIG. 4 is a view schematically showing a configuration of an example of an image forming apparatus according to the present exemplary embodiment; and

FIG. 5 is a view schematically showing a configuration of an example of a control system in an image forming apparatus according to the present exemplary embodiment.

### DETAILED DESCRIPTION

Hereinafter, present exemplary embodiments of the present invention will be described. The following descriptions and examples merely illustrate the exemplary embodiments, and do not limit the scope of the exemplary embodiments.

Regarding the numerical ranges described in stages in the present exemplary embodiment, the upper limit value or lower limit value of a numerical range may be replaced with the upper limit value or lower limit value of another numerical range described in stages. In addition, in the present exemplary embodiment, the upper limit value or lower limit value of a numerical range may be replaced with values described in examples.

In the present exemplary embodiments, the term “step” includes not only an independent step but a step which is not clearly distinguished from other steps as long as the intended purpose of the step is achieved.

In the present exemplary embodiment, in a case where an exemplary embodiment is described with reference to drawings, the configuration of the exemplary embodiment is not limited to the configuration shown in the drawings. In addition, the sizes of members in each drawing are conceptual and do not limit the relative relationship between the sizes of the members.

In the present exemplary embodiments, each component may include a plurality of corresponding substances. In the present exemplary embodiment, in a case where the amount of each component in a composition is mentioned, and there are two or more kinds of substances corresponding to each component in the composition, unless otherwise specified, the amount of each component means the total amount of two or more kinds of the substances present in the composition.

### Fixing Device

The fixing device according to the present exemplary embodiment includes a heating belt, a pressurizing roll, and a heating device.

The heating belt is a belt having a metal layer and a surface layer provided on the metal layer.

The pressurizing roll is a roll that comes into contact with the heating belt and pressurizes the heating belt.

The heating device is a device that heats the heating belt at a position other than a contact portion between the heating belt and the pressurizing roll.

The surface layer of the heating belt contains a polysiloxane compound having a T unit represented by a formula: [R¹SiO_{3/2}]ₘ. In the formula, R¹ is an organic group, m is an integer of 2 or more, and at least one R¹ in the T unit is a group including at least one of an alkyl group or an aryl group. The polysiloxane compound will also be referred to as “polysiloxane compound SQ”.

With the above-described configuration, the fixing device according to the present exemplary embodiment has high release properties of the heating belt and suppresses occurrence of unevenness in image glossiness caused by wrinkles of the surface layer of the heating belt. The reason is presumed as follows.

In the related art, in order to improve energy saving performance, a belt type fixing device that employs a heating belt has been adopted.

On the other hand, in order to improve release properties, a fluororesin is used in a surface layer of the heating belt.

Here, since the heating belt has a small heat capacity, a temperature difference between a region through which a recording medium passes (hereinafter, “paper passing portion”) and a region through which the recording medium does not pass (hereinafter, “non-paper passing portion”) is likely to be large.

In a case where the temperature difference is large, in a heating belt having a layer structure in which the surface layer containing a fluororesin is provided on a metal layer, a large strain is repeatedly applied to the surface layer of the heating belt, resulting in wrinkling deformation (that is, permanent elongation) of the surface layer. As a result, wrinkles having large roughness occur in the surface layer.

In particular, in a fixing device employing a heating device that heats the heating belt at a position other than a contact portion between the heating belt and the pressurizing roll, the above-described temperature difference is maintained in the contact portion for a long time. Therefore, the wrinkling deformation (that is, the permanent elongation) of the surface layer is likely to remain.

In a case where the wrinkling deformation (that is, the permanent elongation) of the surface layer occurs, the image is uneven in glossiness.

On the other hand, in the fixing device according to the present exemplary embodiment, the polysiloxane compound SQ is applied to the surface layer of the heating belt. The polysiloxane compound SQ has high release properties as a heat-resistant release material. In addition, the polysiloxane compound SQ is less likely to have a large difference in thermal expansion coefficient between the paper passing portion and the non-paper passing portion as compared with the fluororesin. Therefore, the wrinkling deformation of the heating belt at a boundary portion between the paper passing portion and the non-paper passing portion is suppressed. As a result, the occurrence of image defects caused by the wrinkling deformation of the heating belt is suppressed in the fixed image.

Accordingly, even in a case where the temperature difference occurs between the paper passing portion and the non-paper passing portion in the heating member by the fixing, the surface layer is less likely to be wrinkled due to the difference in thermal expansion coefficient. As a result, the unevenness in image glossiness caused by the wrinkles of the surface layer is less likely to occur.

From the above, it is presumed that the fixing device according to the present exemplary embodiment has high release properties of the heating belt and suppresses the occurrence of unevenness in image glossiness caused by wrinkles of the surface layer of the heating belt.

Hereinafter, details of the fixing device according to the present exemplary embodiment will be described.

### First Exemplary Embodiment

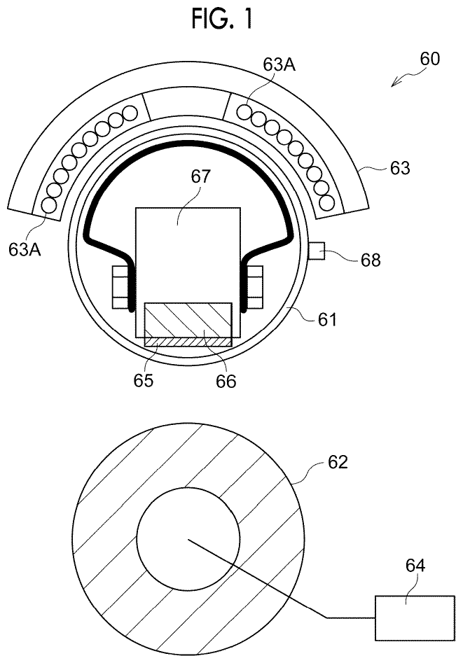

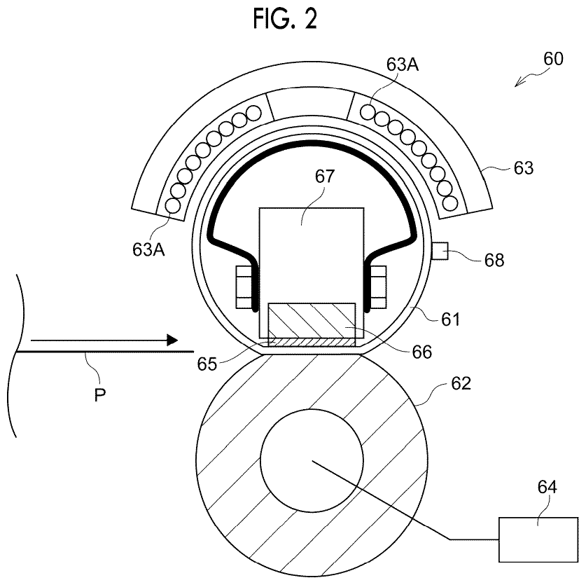

As a fixing device according to a first exemplary embodiment, a fixing device of an electromagnetic induction heating method will be described with reference to FIGS. 1 and 2.

### Configuration of Fixing Device

As shown in FIGS. 1 and 2, a fixing device 60 according to the first exemplary embodiment includes a heating belt 61 (an example of the heating belt), a pressurizing roll 62 (an example of the pressurizing roll), an electromagnetic induction heating device 63 (an example of the heating device), a latch mechanism 64, and a temperature sensor 68.

In FIG. 1, an example of a state in which the pressurizing roll 62 is moved to a spaced position spaced from the heating belt 61 is shown. In FIG. 2, an example of a state in which the pressurizing roll 62 is moved to a pressurized position at which the pressurizing roll 62 is in contact with the heating belt 61 to pressurize the heating belt 61 is shown.

The heating belt 61 has a base material layer, a metal heat generation layer, an elastic layer, and a surface layer in this order.

The pressurizing roll 62 has a base material layer, an elastic layer, and a surface layer in this order.

Details of the heating belt 61 and the pressurizing roll 62 will be described later.

A sliding sheet 65, a pressing pad 66, and a support member 67 are provided inside the heating belt 61.

The sliding sheet 65 is provided between the pressing pad 66 and the heating belt 61. The sliding sheet 65 reduces a sliding resistance between the heating belt 61 and the pressing pad 66.

The pressing pad 66 is provided to press the heating belt 61 toward the pressurizing roll 62 side through the heating belt 61 in a case where the pressing pad 66 is moved to a pressurized position at which the heating belt 61 is pressurized.

The support member 67 is provided to support the pressing pad 66.

The electromagnetic induction heating device is a device that heats the metal heat generation layer of the heating belt 61 by electromagnetic induction.

A plurality of excitation coils 63A that generate a magnetic field by being supplied with power from a fixing power supply are provided in the electromagnetic induction heating device 63.

The electromagnetic induction heating device 63 changes the magnetic field generated from the excitation coils 63A by an excitation circuit. As a result, an eddy current is generated in the metal heat generation layer of the heating belt 61. The eddy current is converted into Joule heat by an electrical resistance of the metal heat generation layer, and the metal heat generation layer generates heat. As a result, the heating belt 61 is heated.

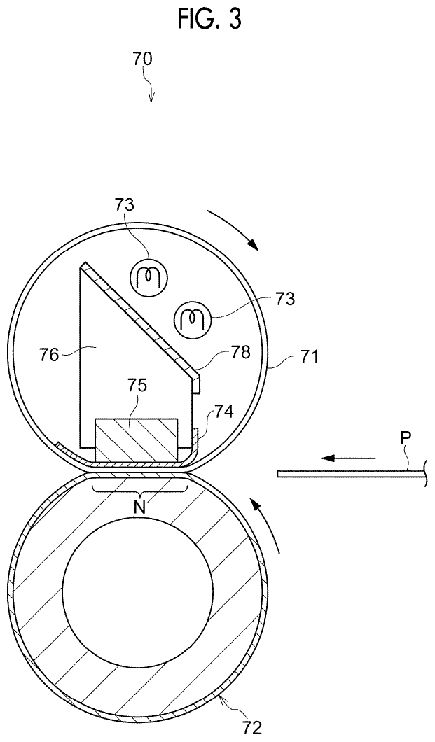

The latch mechanism 64 is a mechanism that moves the pressurizing roll 62 between a spaced position (that is, the position in FIG. 2) and the pressurized position (that is, the position in FIG. 3).

In a case where the pressurizing roll 62 is in the spaced position, a drive target of a drive device (motor or the like; not shown) is switched to the heating belt 61. The heating belt 61 is rotationally driven by the drive device.

On the other hand, in a case where the pressurizing roll 62 is moved to the pressurized position by the latch mechanism 64, the drive target of the drive device (a motor or the like; not shown) is switched to the pressurizing roll 62, and the pressurizing roll 62 is rotationally driven by the drive device. In this case, the heating belt 61 is rotationally driven to follow the rotation of the pressurizing roll 62.

The temperature sensor 68 is provided around the heating belt 61. The temperature sensor 68 measures a surface temperature of the heating belt.

In the fixing device 60, for example, before the fixing is started, the operation of heating the metal heat generation layer of the heating belt 61 by the electromagnetic induction heating device 63 is performed in a state where the heating belt 61 spaced from the pressurizing roll 62 is rotationally driven, and then the operation of bringing the heating belt 61 into contact with the pressurizing roll 62 is performed to start the fixing.

Specifically, for example, in the fixing device 60, in a case where the image formation is started, the heating belt 61 is rotationally driven in a state in which the pressurizing roll 62 is in the spaced position before the fixing is started. A rotation speed of the heating belt 61 herein is set to be lower than the rotation speed during the fixing.

Next, the magnetic field is generated from the excitation coils 63A of the electromagnetic induction heating device 63 to heat the metal heat generation layer of the heating belt 61. As a result, the heating belt 61 is heated.

Next, the pressurizing roll 62 is moved to the pressurized position by the latch mechanism 64, and the pressurizing roll 62 is pressurized against the pressing pad 66 through the heating belt 61 and the sliding sheet 65.

Paper P (an example of the recording medium) on which the toner image is transferred is transported to a contact region between the heating belt 61 and the pressurizing roll 62 in a state in which the heating belt 61 and the pressurizing roll 62 are pressurized. As a result, the toner image is fixed to the paper P.

After the fixing operation is completed, the pressurizing roll 62 is moved to the spaced position by the latch mechanism 64.

A program that executes the above operation is referred to as “fixing operation program”.

In the fixing device 60, the heating belt 61 and the pressurizing roll 62 are spaced from each other during a non-fixing operation, and the heating belt 61 and the pressurizing roll 62 are brought into contact with each other and pressurized only during the fixing operation. Therefore, the surface layer of the heating belt 61 is in a deformed state due to the mechanical load for a shorter period of time. Therefore, the surface layer of the heating belt 61 is less likely to be wrinkled, and the unevenness in image glossiness caused by the wrinkles is less likely to occur.

Here, the operation of bringing the heating belt 61 and the pressurizing roll 62 into contact with each other is preferably performed after a surface temperature T1 of the heating belt 61 reaches 120° C. or higher (for example, preferably 120° C. or higher and 150° C. or lower).

For example, it is preferable to start the fixing after a surface temperature T2 of the heating belt 61 reaches 130° C. or higher (for example, preferably 130° C. or higher and 170° C. or lower).

By performing the contact operation between the heating belt 61 and the pressurizing roll 62 and the fixing start under the above-described temperature conditions, the surface layer is less likely to be wrinkled due to the difference in linear expansion coefficient between the metal base material layer and the surface layer in the heating belt 61. As a result, the unevenness in image glossiness is less likely to occur.

Hereinafter, details of the heating belt 61 and the pressurizing roll 62, applied to the fixing device 60 according to the first exemplary embodiment, will be described.

### Heating Belt

The heating belt 61 has a base material layer, a metal heat generation layer, an elastic layer, and a surface layer in this order. The elastic layer is provided as necessary.

Specifically, for example, the heating belt 61 has a base material layer, a base metal layer, a metal heat generation layer, a metal protective layer, an elastic layer, and a surface layer laminated in this order.

### Base Material Layer

Examples of the base material layer include a resin base material layer consisting of a heat-resistant resin belt.

Examples of the heat-resistant resin belt include a heat-resistant resin belt formed of polyimide, polyamideimide, polyphenylene sulfide, polyether ether ketone, polybenzimidazole, or the like.

The heat-resistant resin belt may contain a conductive powder or the like in order to control a volume resistivity. Specifically, examples of the heat-resistant resin belt include a polyimide resin belt in which carbon black is added and dispersed. In addition, examples of the heat-resistant resin belt also include a belt formed by combining both ends of a long polyimide sheet in a puzzle shape and performing thermocompression using a thermocompression member to obtain a belt-shaped product.

Furthermore, the term “heat-resistant” means a characteristic that melting or decomposition does not occur in a case of reaching a raised temperature of the fixing device (for example, a fixing temperature).

A thickness of the heat-resistant resin belt is, for example, preferably 20 μm or more and 200 μm or less, more preferably 30 μm or more and 150 μm or less, and still more preferably 40 μm or more and 130 μm or less.

### Base Metal Layer

The base metal layer is a layer that is formed in advance in order to form the metal heat generation layer on an outer peripheral surface of the base material layer by an electrolytic plating method.

Examples of the base metal layer include an electroless nickel-plating layer and an electroless copper-plating layer. The “nickel-plating layer” represents a plating layer containing Ni (for example, a nickel layer, a nickel alloy layer, or the like); and the “copper-plating layer” represents a plating layer containing Cu (for example, a copper layer, a copper alloy layer, or the like).

### Metal Heat Generation Layer

The metal heat generation layer is a heat generation layer that has a function of generating heat by an eddy current generated in the layer in a case where a magnetic field is applied, and is composed of a metal that generates an electromagnetic induction effect. Examples of the metal that generates the electromagnetic induction effect include a metal single substance such as nickel, iron, copper, gold, silver, aluminum, chromium, tin, and zinc, and an alloy containing two or more kinds of metals.

### Metal Protective Layer

The metal protective layer is a layer for improving a film strength of the metal heat generation layer, for suppressing cracking due to repeated deformation, oxidation deterioration due to repeated heating for a long time, and the like, and for maintaining heat generation characteristics. The metal protective layer is provided in contact with the metal heat generation layer.

The metal protective layer is, for example, preferably a thin film having a high breaking strength, high durability, and high oxidation resistance, and is, for example, preferably made of a metal having oxidation resistance. Specifically, for example, the metal protective layer is usually composed of copper or nickel, and it is preferably composed of nickel (or a nickel alloy) that is a metal having oxidation resistance, from the viewpoint of suppressing the occurrence of cracking due to repeated deformation, oxidation deterioration due to repeated heating, and the like.

### Elastic Layer

The elastic layer is, for example, an elastic layer that is deformed by an external force of 100 Pa but is restored to the original shape.

The elastic layer may be, for example, a layer containing a heat-resistant elastic material as a principal component.

The layer containing the heat-resistant elastic material as a principal component is a layer in which the heat-resistant elastic material is most contained as a component among components constituting the elastic layer.

Furthermore, the term “heat-resistant” means a characteristic that melting or decomposition does not occur in a case of reaching a raised temperature of the fixing device (for example, a fixing temperature).

Examples of the heat-resistant elastic material include silicone rubber and the like, that are suitable from the viewpoint of heat resistance, thermal conductivity, insulating properties, and the like.

Examples of the silicone rubber include RTV silicone rubber, HTV silicone rubber, and liquid silicone rubber; and specific examples thereof include polydimethyl silicone rubber (MQ), methyl vinyl silicone rubber (VMQ), methyl phenyl silicone rubber (PMQ), and fluorosilicone rubber (FVMQ).

Examples of a commercially available product of the silicone rubber include liquid silicone rubber SE6744 manufactured by Dow Corning Toray Co., Ltd.

As the silicone rubber, for example, silicone rubber that is crosslinked generally by an addition reaction is preferable. In addition, various types of functional groups are known for silicone rubber, and for example, dimethyl silicone rubber having a methyl group, methyl phenyl silicone rubber having a methyl group and a phenyl group, vinyl silicone rubber having a vinyl group (vinyl group-containing silicone rubber), or the like is preferable. For example, vinyl silicone rubber having a vinyl group is more preferable, and silicone rubber that has an organopolysiloxane structure having a vinyl group and a hydrogen organopolysiloxane structure having a hydrogen atom bonded to a silicon atom (SiH) is still more preferable.

For example, it is preferable that the elastic layer contains, as the heat-resistant elastic material, silicone rubber as a principal component (that is, contains 50% by mass or more of the silicone rubber with respect to the elastic layer). The content of the silicone rubber is, for example, more preferably 90% by mass or more, and still more preferably 99% by mass or more.

In addition to the heat-resistant elastic material, the elastic layer may contain an inorganic filler for the purpose of reinforcement, heat resistance, heat transfer, and the like. Examples of the inorganic filler include known inorganic fillers, and preferred examples thereof include fumed silica, crystalline silica, iron oxide, alumina, and metallic silicon.

A content of the inorganic filler may be determined by the required thermal conductivity, mechanical strength, and the like, and is, for example, 1% by mass or more and 20% by mass or less with respect to the elastic layer, preferably 3% by mass or more and 15% by mass or less, and more preferably 5% by mass or more and 10% by mass or less.

The elastic layer may contain, as an additive, for example, a softener (such as a paraffin-based softener), a processing aid (such as stearic acid), an antioxidant (such as an amine-based antioxidant), a vulcanizing agent (such as sulfur, a metal oxide, and a peroxide), a functional filler (such as alumina), or the like.

A thickness of the elastic layer is, for example, preferably 30 μm or more and 600 μm or less, and more preferably 100 μm or more and 500 μm or less.

### Surface Layer

The surface layer contains the polysiloxane compound SQ having a T unit represented by a formula: [R¹SiO_{3/2}]ₘ (in the formula, R¹ is an organic group, m is an integer of 2 or more, and at least one R¹ in the T unit is a group including at least one of an alkyl group or an aryl group).

The surface layer may be a surface layer containing the polysiloxane compound SQ as a principal component (for example, a matrix material that is to be a binding material), or a surface layer containing the polysiloxane compound as an additive. The surface layer may contain other additives.

Here, the surface layer containing the polysiloxane compound SQ as a principal component (for example, a matrix material that is to be a binding material) refers to a surface layer having the highest amount (% by volume) of the polysiloxane compound.

### Polysiloxane Compound SQ

The polysiloxane compound SQ is a polysiloxane compound having a T unit represented by a formula: [R¹SiO_{3/2}]ₘ (in the formula, R¹ represents an organic group, m represents an integer of 2 or more, and at least one R¹ among a plurality of R¹'s present in the T unit is a group including at least one of an alkyl group or an aryl group).

The polysiloxane compound SQ may be a polysiloxane compound having a D unit represented by a formula: (R²R³SiO_{2/2})ₙ (in the formula, R² and R³ are organic groups, and n is an integer of 2 or more), together with the T unit represented by the formula: [R¹SiO_{3/2}]ₘ. For example, in a case of having the D unit, the surface layer can be appropriately stretched, and the wrinkles of the surface layer are less likely to occur, which is preferable.

For example, it is preferable that at least one of R² or R³ among a plurality of R²'s and R³'s present in the D unit is a group including at least one of an alkyl group or an aryl group.

In the T unit and the D unit, the organic group of R¹, R², and R³ in the formulae represents, for example, a hydroxyl group, a siloxy group, a hydrocarbon group, a hydrocarbon group in which one or a plurality of methylene groups are replaced with a carbonyl group, a hydrocarbon group in which one or a plurality of carbon atoms are replaced with a heteroatom (an oxygen atom, a nitrogen atom, or a sulfur atom), or a group obtained by combining these groups.

Examples of the siloxy group described as the organic group represented by R¹, R², and R³ include a monoalkylsiloxy group, a dialkylsiloxy group, and a trialkylsiloxy group; and for example, a dialkylsiloxy group or a trialkylsiloxy group is preferable, and a trialkylsiloxy group is more preferable.

Examples of the hydrocarbon group described as the organic group represented by R¹, R², and R³ include an aliphatic hydrocarbon group and an aromatic hydrocarbon group.

Examples of the aliphatic hydrocarbon group include a linear, branched, or alicyclic saturated aliphatic hydrocarbon group, and a linear, branched, or alicyclic unsaturated aliphatic hydrocarbon group.

The aliphatic hydrocarbon group is, for example, preferably a hydrocarbon group having 1 or more and 20 or less carbon atoms, and more preferably a hydrocarbon group having 1 or more and 15 or less carbon atoms.

The aliphatic hydrocarbon group may be substituted with a substituent such as a halogen atom, a hydroxyl group, an amino group, and an aryl group.

Examples of the aromatic hydrocarbon group include a hydrocarbon group having 6 or more and 18 or less carbon atoms (for example, preferably 6 or more and 14 or less carbon atoms). Examples of the aromatic hydrocarbon group include a phenyl group, a naphthyl group, and an anthracenyl group.

The aromatic hydrocarbon group may be substituted with a substituent such as a halogen atom, a hydroxyl group, an amino group, an alkyl group, and an alkoxy group.

The organic group represented by R¹, R², and R³ may have a reactive group. Examples of the reactive group include a vinyl group, an allyl group, a styryl group, a maleimide group, an epoxy group, and a (meth)acryloyl group. That is, the siloxane compound may be a cured product in which the above-described reactive group is reacted.

A plurality of R¹'s, R²'s, and R³'s present in the T unit and the D unit may be the same organic group or different organic groups.

However, at least one R¹, R², or R³ among the plurality of R¹'s, R²'s, and R³'s present in the T unit is a group including at least one of an alkyl group or an aryl group.

In addition, at least one R¹, R², or R³ among the plurality of R¹'s, R²'s, and R³'s present in the D unit is, for example, preferably a group including at least one of an alkyl group or an aryl group.

That is, at least one R¹ among the plurality of R¹'s present in the T unit is a group including at least one of an alkyl group or an aryl group.

At least one R² among the plurality of R²'s present in the D unit is a group including at least one of an alkyl group or an aryl group.

For example, it is preferable that at least one R³ among the plurality of R³'s present in the D unit is a group including at least one of an alkyl group or an aryl group.

Here, from the viewpoint of improving the release properties, as the group including an alkyl group, for example, an alkyl group itself or a siloxy group including an alkyl group is preferable. That is, at least one of a plurality of R's present in the structure A is, for example, preferably an alkyl group or a siloxy group containing an alkyl group.

From the viewpoint of improving the release properties, the alkyl group is, for example, preferably an alkyl group having 1 or more and 6 or less carbon atoms, and more preferably an alkyl group having 1 or more and 4 or less carbon atoms or an alkyl group having 1 carbon atom (that is, a methyl group).

As the group including an aryl group, for example, an aryl group itself or an aralkyl group is preferable.

Examples of the aryl group include a phenyl group and a naphthyl group.

Examples of an alkyl group in the aralkyl group include a linear or branched alkyl group having 1 or more and 4 or less carbon atoms. Examples of an aryl group in the aralkyl group include a phenyl group and a naphthyl group. Examples of the aralkyl group include a benzyl group, a 1-phenylethyl group, a 2-phenylethyl group, and a 2-methyl-2-phenylethyl group.

From the viewpoint of improving the release properties, as the group including an aryl group, for example, a phenyl group is preferable.

From the viewpoint of improving the release properties, for example, it is preferable that a presence proportion of the group including at least one of an alkyl group or an aryl group is high.

In the T unit and the D unit, m and n in the formulae represent an integer of 2 or more; and from the viewpoint of improving the release properties, for example, an integer of 8 or more is preferable, and an integer of 8 or more and 10,000 or less is more preferable.

In the T unit and the D unit, the lower limit of a ratio m/n of m and n in the formulae is, for example, preferably 100/0 or more, and more preferably 100/1 or more. In addition, the upper limit of m/n is, for example, preferably 10/90 or less, more preferably 20/80 or less, and still more preferably 25/75 or less.

The ratio m/n, that is, the ratio of the T unit and the D unit is measured as follows. The ratio m/n is calculated based on the peak ratio of the D unit (high ppm side) and the T unit (low ppm side) by solid ²⁹Si NMR.

From the viewpoint of improving the release properties, a content of the polysiloxane compound SQ with respect to the surface layer is, for example, preferably 10% by volume or more, more preferably 30% by volume or more, and still more preferably 50% by volume or more. The upper limit of the content of the polysiloxane compound SQ is 100% by volume.

The polysiloxane compound SQ may be in a particle shape. A volume average particle diameter of the particle-shaped polysiloxane compound SQ is, for example, preferably 0.01 μm or more and 10 μm or less, more preferably 0.01 μm or more and 5 μm or less, and still more preferably 0.01 μm or more and 2.5 μm or less. The volume average particle diameter of the particle-shaped polysiloxane compound SQ is, for example, particularly preferably 2.5 μm or less and more preferably 1 μm or less.

In a case where the volume average particle diameter of the particle-shaped polysiloxane compound SQ is within the above-described range, the release properties are likely to be improved.

The volume average particle diameter of the particle-shaped polysiloxane compound SQ is measured as follows.

A sample is collected from the surface layer. The sample is a sample in which a cut surface along a thickness direction of the surface layer is used as an observation surface.

The observation surface of the sample is observed with a scanning electron microscope to capture an image. In the image, an area of each primary particle of the polysiloxane compound SQ is measured by image analysis, and an equivalent circle diameter thereof is calculated from this area value. The calculation of the equivalent circle diameter is carried out for 100 particles of the polysiloxane compound SQ. A 50% diameter (D50v) in the volume-based cumulative frequency of the obtained equivalent circle diameter is defined as the volume average particle diameter of the polysiloxane compound SQ.

Examples of the polysiloxane compound SQ include a polymer compound referred to as silsesquioxane (SQ) having various skeleton structures.

The polysiloxane compound SQ may have, as a skeleton structure, any of a cage-type structure (a perfect cage-type structure or a cage-type structure), a ladder-type structure, or a random structure.

### Polysiloxane Compound Having D Unit

In addition to the above-described polysiloxane compound SQ, the surface layer may contain a polysiloxane compound PS having a D unit represented by a formula: (R²R³SiO_{2/2})ₙ (in the formula, R² and R³ are organic groups, and n is an integer of 2 or more), together with the T unit represented by the formula: [R¹SiO_{3/2}]ₘ. For example, in a case of containing the polysiloxane compound PS, the surface layer can be appropriately stretched, and the wrinkles of the surface layer are less likely to occur, which is more preferable.

R², R³, and n in the formula have the same meanings as “R², R³, and n” of the D unit described for the polysiloxane compound SQ above.

Examples of the polysiloxane compound PS include dimethyl organopolysiloxane, diphenyl organopolysiloxane, and methylphenyl organopolysiloxane. The polysiloxane compound PS may include a hydroxyl group, a vinyl group, or the like at a terminal or a side chain of the molecule.

A proportion of the polysiloxane compound PS with respect to the polysiloxane compound SQ is, for example, preferably 0% by volume or more and 80% by volume or less, more preferably 5% by volume or more and 75% by volume or less, and still more preferably 5% by volume or more and 70% by volume or less.

### Binding Material

The surface layer may contain a binding material for immobilizing the polysiloxane compound SQ.

Examples of the binding material include a heat-resistant release material.

Examples of the heat-resistant release material include a silicone resin, a silicone rubber, a polyimide resin, a polyether ether ketone (PEEK) resin, a polyphenylene sulfide (PPS) resin, and a polymethylpentene (PMP) resin.

Among these, as the heat-resistant release material, for example, a silicone resin or a silicone rubber is preferable.

Furthermore, the term “heat-resistant” means a characteristic that melting or decomposition does not occur in a case of reaching a raised temperature of the fixing device (for example, a fixing temperature).

Examples of the silicone resin include a methyl-based straight silicone resin, a methylphenyl-based straight silicone resin, an acrylic resin-modified silicone resin, an ester resin-modified silicone resin, an epoxy resin-modified silicone resin, and an alkyd resin-modified silicone resin.

Examples of the silicone rubber include room temperature vulcanizing (RTV) silicone rubber, high temperature vulcanizing (HTV) silicone rubber, and liquid silicone rubber; and specific examples thereof include polydimethyl silicone rubber, methylvinyl silicone rubber, methylphenyl silicone rubber, and fluorosilicone rubber.

### Other Additives

The surface layer may be compounded with other additives. Examples of the additive include a filler (inorganic particles and the like), a softener (paraffin-based softener and the like), a processing aid (stearic acid and the like), and an aging inhibitor (amine-based aging inhibitor and the like).

A thickness of the surface layer is, for example, preferably 5 μm or more and 100 μm or less, and more preferably 10 μm or more and 30 μm or less.

### Linear Thermal Expansion Coefficient

A linear thermal expansion coefficient of the surface layer at 150° C. is, for example, preferably 130 ppm/° C. or less, and more preferably 120 ppm/° C. or less.

In a case where the linear thermal expansion coefficient of the surface layer at 150° C. is within the above-described range, the surface layer is less likely to be wrinkled, and the unevenness in image glossiness is likely to be suppressed.

The linear thermal expansion coefficient of the surface layer at 150° C. is a value measured by a thermal mechanical analyzer (TMA-60 manufactured by Shimadzu Corporation) in accordance with a method described in JIS K 7197:2012.

### Pressurizing Roll

The pressurizing roll 62 has a base material layer, an elastic layer, and a surface layer in this order.

The pressurizing roll 62 may be a roll having the base material layer and the elastic layer in this order, or a roll having the base material layer and the surface layer in this order.

Examples of the base material layer, the elastic layer, and the surface layer in the pressurizing roll 62 include the same configurations as the base material layer, the elastic layer, and the surface layer in the heating belt 61.

However, the polysiloxane compound SQ having the T unit may not be applied to the surface layer. For example, the surface layer may be a layer containing the above-described heat-resistant release material.

### Second Exemplary Embodiment

As a fixing device according to a second exemplary embodiment, a fixing device of a direct heating method will be described with reference to FIG. 3.

As shown in FIG. 3, a fixing device 70 according to the second exemplary embodiment includes a heating belt 71 (an example of the heating belt), a pressurizing roll 72 (an example of the pressurizing roll), and a heating device 73 (an example of the heating device).

The heating belt 71 has a metal base material layer, an elastic layer, and a surface layer in this order. Details of the heating belt 71 will be described later.

A sliding sheet 74, a pressing pad 75, a support member 76, and a reflecting sheet 78 are provided inside the heating belt 71.

The sliding sheet 74 is provided between the pressing pad 75 and the heating belt 71. The sliding sheet 74 reduces a sliding resistance between the heating belt 71 and the pressing pad 75.

The support member 76 is provided to support the pressing pad 75.

The reflecting sheet 78 is a member that reflects radiant heat emitted from the heating device 73. The reflecting sheet 78 is disposed to face an inner peripheral surface of the heating belt 71 through the heating device 73 and to prevent the radiant heat emitted from the heating device 73 from reaching a sandwiching region N.

The pressurizing roll 72 has a base material layer, an elastic layer, and a surface layer in this order. Details of the pressurizing roll 72 will be described later.

The pressurizing roll 72 is provided to face the heating belt 71.

The pressurizing roll 72 is provided to be pressed against the pressing pad 75 through the heating belt 71 and the sliding sheet 74. As a result, in the sandwiching region N, the pressurizing roll 72 is disposed to be in pressure contact with the heating belt 71.

The pressurizing roll 72 is connected to a drive device (not shown) through a gear or the like (not shown). The pressurizing roll 72 is rotationally driven in an arrow direction by the drive device. The heating belt 71 rotates in response to the rotation drive of the pressurizing roll 72.

The heating device 73 is a heating device that emits radiant heat. Examples of the heating device 73 include known heating devices such as a halogen lamp, a ceramic heater, and a carbon heater.

The heating device 73 is provided inside the heating belt 71 between the reflecting sheet 78 and the heating belt 71.

The heating device 73 heats the heating belt 71 with the radiant heat emitted from the heating device 73 and the radiant heat reflected by the reflecting sheet 78, from inside the heating belt 71.

In the fixing device 70, the paper P on which the toner image is transferred is transported to the sandwiching region N, and in the sandwiching region N, the toner image is heated and pressurized by the heating belt 71 and the pressurizing roll 72, and the toner image is fixed to the paper P.

The paper P on which the toner image is fixed is peeled off from the heating belt 71 by a change in curvature of the heating belt 71 at an outlet region of the sandwiching region N.

Hereinafter, details of the heating belt 71 and the pressurizing roll 72, applied to the fixing device 70 according to the second exemplary embodiment, will be described.

### Heating Belt

The heating belt 71 has a metal base material layer, an elastic layer, and a surface layer in this order. The elastic layer is provided as necessary.

### Metal Base Material Layer

Examples of the metal base material layer include a metal belt formed of nickel, aluminum, stainless steel, or the like.

A thickness of the metal base material layer is, for example, preferably 20 μm or more and 200 μm or less, more preferably 30 μm or more and 150 μm or less, and still more preferably 40 μm or more and 130 μm or less.

### Elastic Layer and Surface Layer

As the elastic layer and the surface layer, the elastic layer and the surface layer, described for the heating belt 61 of the fixing device 60 according to the first exemplary embodiment, are adopted.

In addition, a difference in linear thermal expansion coefficient between the surface layer and the metal base material layer and a method of measuring the linear thermal expansion coefficient are the same as the difference in linear thermal expansion coefficient between the surface layer and the metal heat generation layer and the method of measuring the linear thermal expansion coefficient, described for the heating belt 61 of the fixing device 60 according to the first exemplary embodiment.

### Image Forming Apparatus

Next, the image forming apparatus according to the present exemplary embodiment will be described.

The image forming apparatus according to the present exemplary embodiment includes:
an image holder;
a charging device that charges a surface of the image holder;
an electrostatic latent image forming device that forms an electrostatic latent image on the charged surface of the image holder;
a developing device that accommodates a developer containing a toner and develops the electrostatic latent image formed on the surface of the image holder with the developer to form a toner image;
a transfer device that transfers the toner image onto a surface of a recording medium; and
a fixing device that fixes the toner image on the surface of the recording medium.

As the fixing device, the fixing device according to the present exemplary embodiment is adopted.

In the image forming apparatus according to the present exemplary embodiment, the fixing device may be made into each cartridge such that the fixing device is detachable from an image forming apparatus. That is, the image forming apparatus according to the present exemplary embodiment may include the fixing device according to the present exemplary embodiment, as a device configuring a process cartridge.

Hereinafter, the image forming apparatus according to the present exemplary embodiment will be described with reference to a drawing.

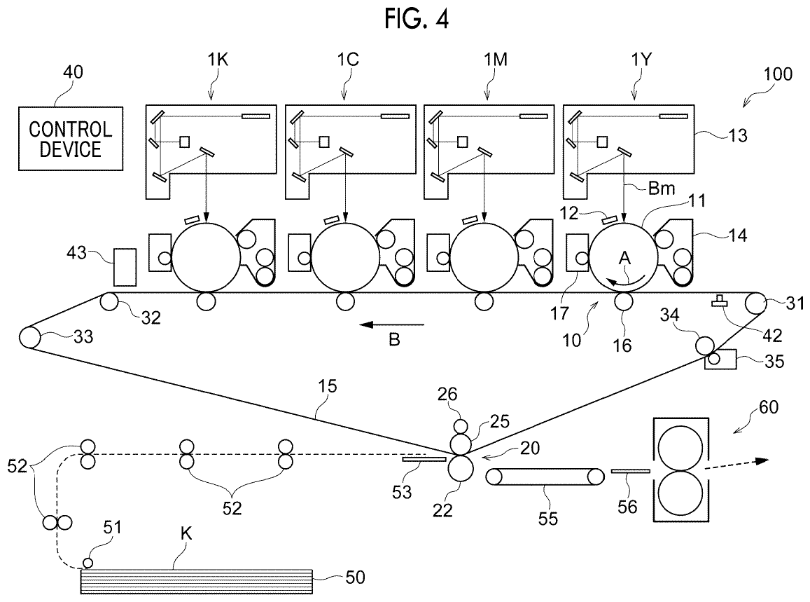

FIG. 4 is a schematic configuration view showing a configuration of the image forming apparatus according to the present exemplary embodiment.

As shown in FIG. 4, an image forming apparatus 100 according to the present exemplary embodiment is, for example, an intermediate transfer-type image forming apparatus generally called a tandem type.

The image forming apparatus 100 includes a plurality of image forming units 1Y, 1M, 1C, and 1K, an intermediate transfer belt 15, a primary transfer unit 10, a secondary transfer unit 20, and the fixing device 60. In addition, the image forming apparatus 100 includes a control device 40 that controls the operation of each device (or each unit).

Here, the image forming units 1Y, 1M, 1C, and 1K are image forming units that form a toner image of each color component by an electrophotographic method.

The primary transfer unit 10 is a transfer unit that sequentially transfers (primary transfers) the toner image of each color component formed by the image forming units 1Y, 1M, 1C, and 1K to the intermediate transfer belt 15.

The secondary transfer unit 20 is a transfer unit that collectively transfers (secondary transfers) the superimposed toner images transferred to the intermediate transfer belt 15 to the paper K that is the recording medium.

The fixing device 60 is a device that fixes the image transferred by the secondary transfer to the paper K.

Each of the image forming units 1Y, 1M, 1C, and 1K of the image forming apparatus 100 includes a photoreceptor 11 that rotates in a direction of an arrow A, as an example of an image holder that holds a toner image formed on the surface.

Around the photoreceptor 11, a charger 12 that charges the photoreceptor 11 is provided as an example of the charging device. Around the photoreceptor 11, a laser exposure device 13 (exposure beam is indicated by a reference numeral Bm in the drawing) that writes an electrostatic latent image on the photoreceptor 11 is provided as an example of the electrostatic latent image forming device.

Around the photoreceptor 11, a developer 14 that accommodates the toner of each color component and visualizes the electrostatic latent image on the photoreceptor 11 with the toner is provided as an example of the developing device.

Around the photoreceptor 11, a primary transfer roll 16 that transfers the toner image of each color component formed on the photoreceptor 11 to the intermediate transfer belt 15 by the primary transfer unit 10 is provided.

Around the photoreceptor 11, a photoreceptor cleaner 17 that removes a residual toner on the photoreceptor 11 is provided.

The charger 12, the laser exposure device 13, the developer 14, the primary transfer roll 16, and the photoreceptor cleaner 17 are sequentially arranged around the photoreceptor 11 along the rotation direction of the photoreceptor 11.

These image forming units 1Y, 1M, 1C, and 1K are substantially linearly arranged in order of yellow (Y), magenta (M), cyan (C), and black (K) from the upstream side of the intermediate transfer belt 15.

By various rolls, the intermediate transfer belt 15 is driven to circulate (rotate) in the direction of an arrow B shown in FIG. 4 at a speed fit for the purpose.

The various rolls include a drive roll 31, a support roll 32, a tension applying roll 33, a back roll 25, and a cleaning back roll 34.

The drive roll 31 is a roll that is driven by a motor (not shown) having an excellent constant speed property and rotates the intermediate transfer belt 15.

The support roll 32 is a roll that supports the intermediate transfer belt 15 extending in a substantially linear shape along the arrangement direction of each photoreceptor 11.

The tension applying roll 33 is a roll that is provided in the secondary transfer unit 20, has a function of applying a tension to the intermediate transfer belt 15, and prevents the intermediate transfer belt 15 from meandering.

The cleaning back roll 34 is a roll that is provided in a cleaning portion that scrapes off the residual toner on the intermediate transfer belt 15.

The primary transfer unit 10 is configured with the primary transfer roll 16 that is disposed to face the photoreceptor 11 across the intermediate transfer belt 15.

The primary transfer roll 16 is disposed to be pressed against the photoreceptor 11 with the intermediate transfer belt 15 therebetween, and a voltage with a polarity (primary transfer bias) opposite to the charging polarity (negative polarity; the same applies hereafter) of the toner is applied to the primary transfer roll 16. As a result, the toner image on each photoreceptor 11 is sequentially electrostatically sucked onto the intermediate transfer belt 15, which leads to the formation of overlapped toner images on the intermediate transfer belt 15.

The secondary transfer unit 20 is configured to include the back roll 25 and a secondary transfer roll 22 that is disposed on a toner image-holding surface side of the intermediate transfer belt 15.

The secondary transfer roll 22 is disposed to be pressed on the back roll 25 across the intermediate transfer belt 15, and the secondary transfer roll 22 is grounded such that the secondary transfer bias is formed between the secondary transfer roll 22 and the back roll 25, that induces secondary transfer of the toner image onto the paper K transported to the secondary transfer unit 20.

In addition, an intermediate transfer belt cleaner 35 is provided on the downstream side of the secondary transfer unit 20 on the intermediate transfer belt 15 to be freely attachable to and detachable from the intermediate transfer belt 15.

The intermediate transfer belt cleaner 35 is a cleaner that removes the residual toner or paper powder on the intermediate transfer belt 15 after the secondary transfer, and cleans the surface of the intermediate transfer belt 15.

The intermediate transfer belt 15, the primary transfer unit 10 (primary transfer roll 16), and the secondary transfer unit 20 (secondary transfer roll 22) correspond to an example of the transfer device.

On the other hand, a reference sensor (home position sensor) 42 is disposed on an upstream side of the yellow image forming unit 1Y.

The reference sensor 42 is a sensor that generates a reference signal serving as a reference for taking an image forming timing in each of the image forming units 1Y, 1M, 1C, and 1K.

The reference sensor 42 recognizes a mark provided on a back side of the intermediate transfer belt 15 to generate the reference signal. Each of the image forming units 1Y, 1M, 1C, and 1K is configured to start the image formation in response to an instruction from the control device 40 based on the recognition of the reference signal.

An image density sensor 43 used to adjust image quality is provided on the downstream side of the black image forming unit 1K.

The image forming apparatus 100 includes a paper storage portion 50, a paper feeding roll 51, a transport roll 52, a transport guide 53, a transport belt 55, and a fixing inlet guide 56.

The paper storage portion 50 is a storage portion that accommodates the paper K, as a transport device that transports the paper K.

The paper feeding roll 51 is a roll that takes out the paper K accumulated in the paper storage portion 50 at a predetermined timing, and transports the paper K.

The transport roll 52 is a roll that transports the paper K fed by the paper feeding roll 51.

The transport guide 53 is a guide that feeds the paper K transported by the transport roll 52 to the secondary transfer unit 20.

The transport belt 55 is a belt that transports the paper K, that is secondarily transferred by the secondary transfer roll 22, to the fixing device 60.

The fixing inlet guide 56 is a guide that guides the paper K to the fixing device 60.

Next, basic image forming process of the image forming apparatus 100 according to the present exemplary embodiment will be described.

In the image forming apparatus 100 according to the present exemplary embodiment, image data output from an image reading device (not shown), a personal computer (PC) (not shown), or the like is subjected to image processing by an image processing device (not shown), and then the image forming units 1Y, 1M, 1C, and 1K perform the image forming operation.

In the image processing device, various types of image processing, such as shading correction, misregistration correction, brightness/color space conversion, gamma correction, frame removal or color editing, and movement editing, are performed on input image data. Image data on which the image processing is performed are converted into color material gradation data of four colors, that is, Y, M, C, and K, and are output to the laser exposure device 13.

In the laser exposure device 13, according to the input color material gradation data, for example, the photoreceptor 11 of each of the image forming units 1Y, 1M, 1C, and 1K is irradiated with an exposure beam Bm emitted from a semiconductor laser. The surface of each of the photoreceptors 11 of the image forming units 1Y, 1M, 1C, and 1K is charged by the charger 12, and is then scanned and exposed by the laser exposure device 13, so that the electrostatic latent image is formed. By each of the image forming units 1Y, 1M, 1C, and 1K, the formed electrostatic latent image is developed as a toner image of each of the colors Y, M, C, and K.

The toner image formed on each of the photoreceptors 11 of the image forming units 1Y, 1M, 1C, and 1K is transferred onto the intermediate transfer belt 15 at the primary transfer unit 10 where each photoreceptor 11 and the intermediate transfer belt 15 are in contact with each other. More specifically, in the primary transfer unit 10, by the primary transfer roll 16, a voltage (primary transfer bias) with a polarity opposite to the charging polarity (negative polarity) of the toner is applied to the base material of the intermediate transfer belt 15, and the toner images are sequentially overlapped on the surface of the intermediate transfer belt 15 and subjected to primary transfer.

After the primary transfer by which the toner images are sequentially transferred to the surface of the intermediate transfer belt 15, the intermediate transfer belt 15 moves, and the toner images are transported to the secondary transfer unit 20. In a case where the toner images are transported to the secondary transfer unit 20, in the transport device, the paper feeding roll 51 rotates in accordance with the timing at which the toner images are transported to the secondary transfer unit 20, and the paper K having the target size is fed from the paper storage portion 50. The paper K fed from the paper feeding roll 51 is transported by the transport roll 52, passes through the transport guide 53, and reaches the secondary transfer unit 20. Before reaching the secondary transfer unit 20, the paper K is temporarily stopped, and a positioning roll (not shown) rotates according to the movement timing of the intermediate transfer belt 15 holding the toner image, so that the position of the paper K is aligned with the position of the toner image.

In the secondary transfer unit 20, through the intermediate transfer belt 15, the secondary transfer roll 22 is pressed on the back roll 25. At this time, the paper K transported at the right timing is interposed between the intermediate transfer belt 15 and the secondary transfer roll 22. At this time, in a case where a voltage (secondary transfer bias) with the same polarity as the charging polarity (negative polarity) of the toner is applied from the power supply roll 26, a transfer electric field is formed between the secondary transfer roll 22 and the back roll 25. In the secondary transfer unit 20 pressed by the secondary transfer roll 22 and the back roll 25, the unfixed toner images held on the intermediate transfer belt 15 are electrostatically transferred onto the paper K in a batch.

Thereafter, the paper K on which the toner image is electrostatically transferred is transported as it is in a state of being peeled off from the intermediate transfer belt 15 by the secondary transfer roll 22. The paper K is transported to the transport belt 55 provided on a downstream side of the secondary transfer roll 22 in the paper transport direction. The transport belt 55 transports the paper K to the fixing device 60 according to the optimum transport speed in the fixing device 60. The unfixed toner images on the paper K transported to the fixing device 60 are fixed on the paper K by being subjected to a fixing treatment by heat and pressure by the fixing device 60. The paper K on which the fixed image is formed is transported to an ejected paper-storing portion (not shown) provided in an output portion of the image forming apparatus 100.

On the other hand, after the transfer to the paper K is completed, the residual toner remaining on the intermediate transfer belt 15 is transported to the cleaning unit with the rotation of the intermediate transfer belt 15. The residual toner is removed from the intermediate transfer belt 15 by the cleaning back roll 34 and the intermediate transfer belt cleaner 35.

Here, the image forming apparatus 100 includes the above-described control device 40 that controls the operation of each device (or each unit).

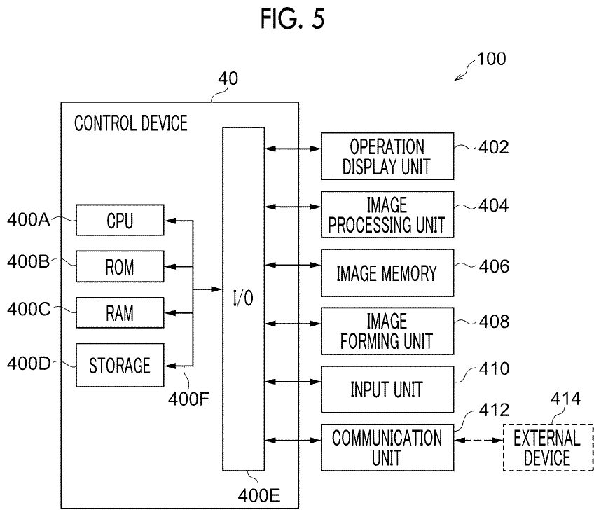

The control device 40 is configured as a computer that controls the entire device and performs various calculations. Specifically, as shown in FIG. 5, the control device 40 includes, for example, a central processing unit (CPU) 400A that is an example of a processor, a read only memory (ROM) 400B storing various programs, a random access memory (RAM) 400C used as a work area in a case of executing a program, a storage 400D storing various pieces of information, and an input/output interface (I/O) 400E. Each of the CPU 400A, the ROM 400B, the RAM 400C, the storage 400D, and the I/O 400E is connected to each other through a bus 400F.

The CPU 400A is a central processing unit that executes various programs or controls each unit. That is, the CPU 400A reads out a program from the ROM 400B or the storage 400D and executes the program using the RAM 400C as a work area. The CPU 400A performs control of each of the components described above and various computational processes in accordance with the programs recorded in the ROM 400B or the storage 400D.

The ROM 400B stores various programs and various data.

The RAM 400C temporarily stores a program or data as the work area.

The storage 400D is configured with a hard disk drive (HDD) or a solid state drive (SSD) and stores various programs including an operating system and various types of data.

In addition to the “image forming operation program”, various programs of the “fixing operation program” described above are stored in the ROM 400B or the storage 400D.

In addition, the image forming apparatus 100 includes an operation display unit 402, an image processing unit 404, an image memory 406, an image forming unit 408, a storage unit 410, and a communication unit 412, outside the control device 40. Each unit of the operation display unit 402, the image processing unit 404, the image memory 406, the image forming unit 408, the storage unit 410, and the communication unit 412 is connected to the I/O 400E of the control device 40. The control device 40 exchanges information with each unit of the operation display unit 402, the image processing unit 404, the image memory 406, the image forming unit 408, the storage unit 410, and the communication unit 412 to control each unit.

The operation display unit 402 includes a touch panel for displaying various buttons such as a start button and a ten-key, and various screens such as a warning screen and a setting screen. With the above-described configuration, the operation display unit 402 receives an operation from the user, and displays various types of information to the user.

The image processing unit 404 performs predetermined image processing on the image information acquired from an external device 414 through the communication unit 412 to generate image information for output to the image forming unit 408. For example, PDL data written in a page description language is subjected to an expansion process to be converted into raster data (RGB data) expanded into each of RGB colors, and the RGB data is subjected to a color conversion process to generate YMCK data and the like expressed in colors reproduced by the image forming apparatus. Furthermore, a screen process, a gamma correction process, or the like may be performed.

The image memory 406 stores various types of image information acquired by the image forming apparatus 100, such as the image information acquired from the external device 414 and the image information generated by the image processing unit 404. The image memory 406 stores, for example, at least the image information subjected to the image processing by the image processing unit 404, that is, the image information for output to the image forming unit 408.

The image forming unit 408 has been described as a principal configuration of the image forming apparatus 100. The image forming unit 408 is, for example, the image forming units 1Y, 1M, 1C, and 1K, the fixing device 60, or the like. Each of these units is connected to the control device 40. The control device 40 exchanges information with each unit to control each unit and the like.

The input unit 410 includes a pointing device, such as a mouse, and a keyboard and is used to perform various inputs.

The communication unit 412 is an interface for communicating with the external device 414 through a wired or wireless communication line, and for example, standards such as Ethernet (registered trademark), FDDI, and Wi-Fi (registered trademark) are used. For example, the communication unit 412 acquires image forming information from the external device 414, together with image forming instruction or image information of the electronic document. The image forming information includes a parameter representing an attribute such as the type (size and the like) of the paper K, a paper feeding direction of the paper K, the number of copies, and a color mode.

In the control device 40, the CPU 400A that is an example of a processor executes the “fixing operation program” to operate the fixing device 60.

The term “processor” refers to hardware in a broad sense, and examples thereof include general processors (for example, Central Processing Unit (CPU) and the like) and dedicated processors (for example, Graphics Processing Unit (GPU), Application Specific Integrated Circuit (ASIC), Field Programmable Gate Array (FPGA), programmable logic device, and the like).

The operations of the processor may be implemented by one processor, and may also be implemented by the cooperation of a plurality of processors that are present at physically separated positions. Alternatively, a plurality of operations performed by a specific plurality of processors in each of the above-described exemplary embodiments may be partially or entirely integrated and performed by one processor. In addition, the order of each operation of the processor is not limited to one described in each of the above-described exemplary embodiments, and may be changed as appropriate.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

A program for operating the image forming apparatus 100 may be provided by a computer-readable recording medium, such as a universal serial bus (USB) memory, a flexible disk, or a compact disc read only memory (CD-ROM), or may be provided on line via a network such as the Internet. In this case, the program recorded on the computer-readable recording medium is typically transferred to and stored in a memory, a storage, or the like. In addition, for example, the program may be provided as independent application software, or may be incorporated into software of each device as a function of the image forming apparatus 100. Although the present exemplary embodiment has been described, the present exemplary embodiment is not limited to the above-described exemplary embodiments, and various modifications, changes, and ameliorations can be added thereto.

### EXAMPLES

### Example A

### Production of Heating Belt A1

### Formation of Resin Base Material Layer

A polyimide precursor (polyimide varnish “Uvarnish-S”, manufactured by UBE Corporation) in N-methyl-2-pyrrolidone (NMP) solution (concentration of solid contents: 18% by mass) is spiral-coated on a mold having a diameter of φ30 mm such that a film thickness is 60 μm, and is baked by the following stepwise heating up to 380° C. In the stepwise heating, the temperature is increased from 25° C. to 120° C., maintained at 120° C. for 1 hour, increased from 120° C. to 250° C., maintained at 250° C. for 1 hour, increased from 250° C. to 380° C., maintained at 380° C. for 1 hour, and then reduced from 380° C. to 25° C.

As a result, a tubular polyimide resin belt (hereinafter, PI base material) consisting of a single layer of a polyimide resin layer having an outer diameter of 30 mm, a film thickness of 60 μm, and a width of 400 mm is obtained. The PI base material is used as a resin base material layer.

A surface of the PI base material is subjected to a roughening treatment using a liquid honing device (LH-8TTHiS manufactured by FUJI SEIKI Co., Ltd.) to have a surface roughness Ra of 0.5 μm or more and 1.0 μm or less. As honing conditions, abrasive grains #320 are used, the jet pressure is set to 0.3 MPa, the jet distance is set to 100 mm, and the treatment time is set to 1.5 minutes. Abrasive grains on the surface of the roughened PI base material are washed away with ion exchange water, and the moisture on the surface of the PI base material is removed with compressed air.

### Formation of Each Metal Layer

Next, the PI base material is incorporated into a plating jig, and an electroless nickel-plating layer (that is, a metal underlayer) having a thickness of 0.5 μm is formed by an electroless plating treatment.

Next, after forming the electroless copper plating layer (metal underlayer), electrodes are set at both ends of the plating jig, and an electrolytic plating treatment is carried out using a copper sulfate plating liquid to form an electrolytic copper-plating layer (that is, a metal heat generation layer) having a thickness of 10 μm.

Next, electrodes are set at both ends of the plating jig, and an electrolytic nickel plating treatment is carried out using an electrolytic plating liquid to form an electrolytic nickel-plating layer (that is, a metal protective layer) having a thickness of 10 μm.

### Formation of Elastic Layer

Next, a liquid obtained by mixing equal amounts of an A liquid and a B liquid of PRIMER-NO.32 (two-liquid type silicone rubber primer, manufactured by Shin-Etsu Chemical Co., Ltd.) is prepared, and then the liquid is applied onto the surface of the electrolytic nickel-plating layer using a spiral coating device, and dried at room temperature for 30 minutes and baked at 170° C. for 20 minutes to form an adhesive layer having a film thickness of 0.2 μm.

Next, silicone rubber (X34-1053-A/B, manufactured by Shin-Etsu Chemical Co., Ltd.) is diluted with butyl acetate such that a concentration of solid contents is 85% by mass to obtain a coating liquid for forming an elastic layer. The coating liquid for forming an elastic layer is applied onto the surface (that is, the outer peripheral surface) of the adhesive layer using a spiral coating device to a thickness of 200 μm to form a coating film.

Next, the formed coating film is subjected to a self-leveling treatment (30° C.×5 minutes) and primary vulcanization (120° C.×20 minutes) to form an elastic layer.

### Formation of Surface Layer

Next, a coating liquid having the following formulation is applied onto the surface of the elastic layer by a spiral coating method, dried at 120° C. for 10 minutes, and heated at 170° C. for 10 minutes to form a surface layer having a thickness of 30 μm.

The formulation of the coating liquid is as follows.
Polysiloxane compound SQ1: “SR-13H”, KONISHI CHEMICAL IND CO., LTD., polysiloxane compound having only T unit represented by the formula: [R¹SiO_{3/2}]ₘ (in the formula, R¹=a methyl group): amount of “% by volume (with respect to surface layer)” shown in Table 1
Solvent: butyl acetate: amount of 10% by mass of the coating liquid (that is, amount at which solid content is 90% by mass)

As a result of the above-described operation, a heating belt is obtained.

### Production of Heating Belts A2 to A6 and AC2

A heating belt is obtained in the same manner as in the heating belt A1, except that the following items are changed according to Table 1. However, in some of Examples, the polysiloxane compound SP is used in combination with the polysiloxane compound SQ. In the heating belt AC2, only the polysiloxane compound SP is used as the polysiloxane compound.
Type and amount of polysiloxane compound SQ (amount is content with respect to surface layer)
Type and amount of polysiloxane compound SP (amount is content with respect to surface layer)

### Heating Belt AC1

The resin base material layer to the elastic layer are formed in the same manner as in the heating belt A1.

Next, a tube (manufactured by GUNZE LIMITED) made of a tetrafluoroethylene-perfluoroalkyl vinyl ether copolymer (PFA), having a film thickness of 35 μm, is covered on the elastic layer, and heated at 200° C. for 120 minutes to form a surface layer consisting of a fluororesin tube.

### Examples A1 to A10 and Comparative Examples A1 and A2

An image forming apparatus (FUJIFILM Business Innovation Corp., “Apeos C5570”) including a fixing device of an electromagnetic induction heating method (referred to as “IH type” in the table) is prepared.

Each of the above-described heating belts is mounted as a heating belt of the fixing device of the image forming apparatus.

The obtained image forming apparatus is used as an image forming apparatus of each example. Next, the following evaluation is performed.

Here, the fixing device of the image forming apparatus of each example is a device that starts the fixing by performing the operation of heating the metal heat generation layer by the electromagnetic induction heating device in a state in which the heating belt is rotationally driven while being spaced from the pressurizing roll before the fixing start, and then performing the operation of bringing the heating belt and the pressurizing roll into contact with each other.

A surface temperature T1 of the heating belt in a case of performing the operation of bringing the heating belt and the pressurizing roll into contact with each other and a surface temperature T2 of the heating belt in a case of starting the fixing are set to the temperatures shown in Table 1.

### Evaluation

### Toner Offset

Toner offset is evaluated as follows using the image forming apparatus of each example. A black solid image is formed on a mirror coat platinum 256 gsm paper (manufactured by Fujifilm Business Innovation Corp.), and the image is evaluated by visual observation. The evaluation standards are as follows.

A+: image defect due to toner offset is not visually recognized in the image.

A: image defect due to toner offset is not visually recognized in the image, and glossiness unevenness is visually recognized in the image, but is within an allowable range.

B: slight image defect due to toner offset is visually recognized in the image, but is within an allowable range.

C: clear image defect due to toner offset is visually recognized in the image.

### Unevenness in Image Glossiness

Unevenness in image glossiness is evaluated as follows using the image forming apparatus of each example.

An image of a black solid image is output on A3 paper for each of 100,000 images while outputting an image of a black halftone density of 10% in a short edge feed (SEF) direction on A4 paper. The same evaluation is performed until 1,000,000 images are output, and then the image quality and the deformation state (that is, wrinkles) of the surface layer of the heating belt are checked. The results are shown in Table 1. The evaluation standards are as follows.

A+: wrinkles are not confirmed in the surface layer of the heating belt, and glossiness unevenness is not visually recognized in the image.

A: slight wrinkles are confirmed in the surface layer of the heating belt, and slight glossiness unevenness is visually recognized in the image, but is within an allowable range.

B: wrinkles are confirmed in the surface layer of the heating belt, and glossiness unevenness is visually recognized in the image, but is within an allowable range.

C: clear wrinkles are confirmed in the surface layer of the heating belt, and clear glossiness unevenness is visually recognized in the image.

### Example B

### Production of Heating Belt B1

### Preparation of Metal Base Material Layer

A nickel-made metal belt having an outer diameter of 30 mm, a film thickness of 40 μm, and a width of 400 mm is prepared, and an inner surface thereof is blackened. The belt is used as a metal base material layer.

### Formation of Elastic Layer

The adhesive layer and the elastic layer are sequentially formed in the same manner as in the heating belt A1.

### Formation of Surface Layer

Next, a coating liquid having the following formulation is applied onto the surface of the elastic layer by a spiral coating method, dried at 120° C. for 10 minutes, and heated at 170° C. for 10 minutes to form a surface layer having a thickness of 30 μm.

The formulation of the coating liquid is as follows.
Polysiloxane compound SQ1: “SR-13H”, KONISHI CHEMICAL IND CO., LTD., polysiloxane compound having only T unit represented by the formula: [R¹SiO_{3/2}]ₘ (in the formula, R¹=a methyl group): amount of “% by volume (with respect to surface layer)” shown in Table 1
Solvent: butyl acetate: amount of 10% by mass of the coating liquid (that is, amount at which solid content is 90% by mass)

After the above-described operation, a width is adjusted to 360 mm to obtain a heating belt.

### Production of Heating Belts B2 to B6 and BC2

A heating belt is obtained in the same manner as in the heating belt B1, except that the following items are changed according to Table 2. However, in some of Examples, the polysiloxane compound SP is used in combination with the polysiloxane compound SQ. In the heating belt BC2, only the polysiloxane compound SP is used as the polysiloxane compound.
Type and amount of polysiloxane compound SQ (amount is content with respect to surface layer)
Type and amount of polysiloxane compound SP (amount is content with respect to surface layer)

### Heating Belt BC1

The metal base material layer to the elastic layer are formed in the same manner as in the heating belt B1.

Next, a tube (manufactured by GUNZE LIMITED) made of a tetrafluoroethylene-perfluoroalkyl vinyl ether copolymer (PFA), having a film thickness of 35 μm, is covered on the elastic layer, and heated at 200° C. for 120 minutes to form a surface layer consisting of a fluororesin tube.

### Examples B1 to B6 and Comparative Examples B1 and B2

An image forming apparatus (Ricoh, Inc., “MPC6003”) including a fixing device of a direct heating method (referred to as “DH type” in the table) is prepared.

Each of the above-described heating belts is mounted as a heating belt of the fixing device of the image forming apparatus.

The obtained image forming apparatus is used as an image forming apparatus of each example. The toner offset and the unevenness in image glossiness are evaluated in the same manner as in Example A1.

### Used Materials

Details of the materials used in each example are as follows.

### Polysiloxane Compound SQ

SQ1: “SR-13H”, KONISHI CHEMICAL IND CO., LTD., polysiloxane compound having only T unit represented by the formula [R¹SiO_{3/2}]ₘ (in the formula, R¹=a methyl group)
SQ2: “SR-23”, KONISHI CHEMICAL IND CO., LTD., polysiloxane compound having only T unit represented by the formula [R¹SiO_{3/2}]ₘ (in the formula, R¹=a phenyl group)

### Polysiloxane Compound SP

SP1: “DOWSIL SH 9555 Clear Base/DOWSIL SH 9555 K Catalyst” of Dow Toray Co., Ltd., polysiloxane compound (that is, dimethyl organosiloxane) having only a D unit represented by a formula: (R²R³SiO_{2/2})ₙ (in the formula, R² and R³=a methyl group)

TABLE 1

| | | Surface layer of heating belt (formulation and characteristics) | | | | | | | | | | | |
|---|---|---|---|---|---|---|---|---|---|---|---|---|---|
| | | | | | | | | Linear | | | | | |
| | | | | | | | | thermal | Fixing device | | | | |
| | | Polysiloxane | | Polysiloxane | | Other | | expansion | | Tem- | Tem- | | |
| | | compound SQ | | compound SP | | components | | coefficient | | per- | per- | Evaluation | |
| | Heating | | Amount | | Amount | | Amount | of surface | | ature | ature | | Unevenness |
| | belt | | (% by | | (% by | | (% by | layer | | T1 | T2 | Toner | in image |
| | Type | Type | volume) | Type | volume) | Type | volume) | ppm/° C. | Method | ° C. | ° C. | offset | glossiness |
| Example A1 | A1 | SQ1 | 100 | — | — | — | — | 30 | IH type | 140 | 150 | A+ | A |
| Example A2 | A2 | SQ1 | 90 | SP1 | 10 | — | — | 90 | IH type | 140 | 150 | A+ | A+ |
| Example A3 | A3 | SQ1 | 80 | SP1 | 20 | — | — | 120 | IH type | 140 | 150 | B | A+ |
| Example A4 | A4 | SQ1 | 50 | SP1 | 50 | — | — | 130 | IH type | 140 | 150 | A | B |
| Example A5 | A5 | SQ1 | 70 | SP1 | 30 | — | — | 150 | IH type | 140 | 150 | B | C |
| Example A6 | A6 | SQ2 | 100 | — | — | — | — | 40 | IH type | 140 | 150 | B | B |
| Example A7 | A2 | SQ1 | 90 | SP1 | 10 | — | — | 90 | IH type | 130 | 150 | A | A |
| Example A8 | A2 | SQ1 | 90 | SP1 | 10 | — | — | 90 | IH type | 120 | 150 | B | A |
| Example A9 | A2 | SQ1 | 90 | SP1 | 10 | — | — | 90 | IH type | 140 | 140 | B | B |
| Example | A2 | SQ1 | 90 | SP1 | 10 | — | — | 90 | IH type | 140 | 130 | C | B |
| A10 | | | | | | | | | | | | | |
| Comparative | AC1 | — | — | | | PFA | 100 | 180 | IH type | 140 | 150 | A | D |
| Example A1 | | | | | | | | | | | | | |
| Comparative | AC2 | — | — | SP1 | 100 | — | — | 250 | IH type | 140 | 150 | D | D |
| Example A2 | | | | | | | | | | | | | |

TABLE 2

| | | Surface layer of heating belt (formulation and characteristics) | | | | | | | | | |
|---|---|---|---|---|---|---|---|---|---|---|---|
| | | | | | | | | Linear | | | |
| | | | | | | | | thermal | | | |
| | | Polysiloxane | | Polysiloxane | | Other | | expansion | | | |
| | | compound SQ | | compound SP | | components | | coefficient | | Evaluation | |
| | Heating | | Amount | | Amount | | Amount | of surface | Fixing | | Unevenness |
| | belt | | (% by | | (% by | | (% by | layer | device | Toner | in image |
| | Type | Type | volume) | Type | volume) | Type | volume) | ppm/° C. | Method | offset | glossiness |
| Example B1 | B1 | SQ1 | 100 | — | — | — | — | 30 | DH | A | B |
| | | | | | | | | | type | | |
| Example B2 | B2 | SQ1 | 90 | SP1 | 10 | — | — | 90 | DH | A+ | A |
| | | | | | | | | | type | | |
| Example B3 | B3 | SQ1 | 80 | SP1 | 20 | — | — | 120 | DH | B | A |
| | | | | | | | | | type | | |
| Example B4 | B4 | SQ1 | 50 | SP1 | 50 | — | — | 130 | DH | A | B |
| | | | | | | | | | type | | |
| Example B5 | B5 | SQ1 | 70 | SP1 | 30 | — | — | 150 | DH | B | C |
| | | | | | | | | | type | | |
| Example B6 | B6 | SQ2 | 100 | — | — | — | — | 40 | DH | B | B |
| | | | | | | | | | type | | |
| Comparative | BC1 | — | — | | | PFA | 100 | 180 | DH | A | D |
| Example B1 | | | | | | | | | type | | |
| Comparative | BC2 | — | — | SP1 | 100 | — | — | 250 | DH | D | D |
| Example B2 | | | | | | | | | type | | |

From the above results, it is found that, in the present example, in any of the fixing devices of the electromagnetic induction heating type and the direct heat type, the toner offset and the unevenness in image glossiness are suppressed as compared with Comparative Examples.

As a result, it is found that, in any of the fixing devices of the electromagnetic induction heating type and the direct heat type, the release properties of the heating belt are high and the unevenness in image glossiness is suppressed.

The present exemplary embodiments include the following aspects.

(((1)))

A fixing device comprising:
a heating belt having a metal layer and a surface layer provided on the metal layer;
a pressurizing roll that comes into contact with the heating belt and that pressurizes the heating belt; and
a heating device that heats the heating belt at a position other than a contact portion between the heating belt and the pressurizing roll,
wherein the surface layer of the heating belt contains a polysiloxane compound having a T unit represented by a formula: [R¹SiO_{3/2}]ₘ (in the formula, R¹ is an organic group, m is an integer of 2 or more, and at least one R¹ in the T unit is a group including at least one of an alkyl group or an aryl group).
   (((2)))

The fixing device according to (((1))),
wherein at least one R¹ in the T unit is a group including an alkyl group.
   (((3)))

The fixing device according to (((2))),
wherein the group including an alkyl group is a methyl group.
   (((4)))

The fixing device according to any one of (((1))) to (((3))),
wherein a linear thermal expansion coefficient of the surface layer of the heating belt at 150° C. is 130 ppm/° C. or less.
   (((5)))

The fixing device according to (((4))),
wherein the linear thermal expansion coefficient of the surface layer of the heating belt at 150° C. is 120 ppm/° C. or less.
   (((6)))

The fixing device according to any one of (((1))) to (((5))),
wherein the heating belt is a belt having a metal base material layer as the metal layer, an elastic layer, and the surface layer in this order, and
the heating device is a heating device that emits radiant heat.
   (((7)))

The fixing device according to any one of (((1))) to (((5))),
wherein the heating belt is a belt having a base material layer, a metal heat generation layer as the metal layer, an elastic layer, and the surface layer in this order, and
the heating device is an electromagnetic induction heating device that heats the metal heat generation layer by electromagnetic induction.
   (((8)))

The fixing device according to (((7))),
wherein, in a state in which the heating belt is rotationally driven while being spaced from the pressurizing roll before a fixing start, after the electromagnetic induction heating device heats the metal heat generation layer, the heating belt and the pressurizing roll are brought into contact with each other to start the fixing.
   (((9)))

The fixing device according to (((8))),
wherein the heating belt and the pressurizing roll are brought into contact with each other after a surface temperature T1 of the heating belt reaches 120° C. or higher, and the fixing is started after a surface temperature T2 of the heating belt reaches 130° C. or higher.
   (((10)))

An image forming apparatus comprising:
an image holder;
a charging device that charges a surface of the image holder;
an electrostatic latent image forming device that forms an electrostatic latent image on the charged surface of the image holder;
a developing device that accommodates a developer containing a toner and develops the electrostatic latent image formed on the surface of the image holder with the developer to form a toner image;
a transfer device that transfers the toner image onto a surface of a recording medium; and
the fixing device according to any one of (((1))) to (((9))), that fixes the toner image on the surface of the recording medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing device comprising:
a heating belt having a metal layer and a surface layer provided on the metal layer;
a pressurizing roll that comes into contact with the heating belt and that pressurizes the heating belt; and
a heating device that heats the heating belt at a position other than a contact portion between the heating belt and the pressurizing roll,
wherein the surface layer of the heating belt contains a polysiloxane compound having a T unit represented by a formula: [R¹SiO_{3/2}]ₘ (in the formula, R¹ is an organic group, m is an integer of 2 or more, and at least one R¹ in the T unit is a group including at least one of an alkyl group or an aryl group).

2. The fixing device according to claim 1,
wherein at least one R¹ in the T unit is a group including an alkyl group.

3. The fixing device according to claim 2,
wherein the group including an alkyl group is a methyl group.

4. The fixing device according to claim 1,
wherein a linear thermal expansion coefficient of the surface layer of the heating belt at 150° C. is 130 ppm/° C. or less.

5. The fixing device according to claim 4,
wherein the linear thermal expansion coefficient of the surface layer of the heating belt at 150° C. is 120 ppm/° C. or less.

6. The fixing device according to claim 1,
wherein the heating belt is a belt having a metal base material layer as the metal layer, an elastic layer, and the surface layer in this order, and
the heating device is a heating device that emits radiant heat.

7. The fixing device according to claim 1,
wherein the heating belt is a belt having a base material layer, a metal heat generation layer as the metal layer, an elastic layer, and the surface layer in this order, and
the heating device is an electromagnetic induction heating device that heats the metal heat generation layer by electromagnetic induction.

8. The fixing device according to claim 7,
wherein, in a state in which the heating belt is rotationally driven while being spaced from the pressurizing roll before a fixing start, after the electromagnetic induction heating device heats the metal heat generation layer, the heating belt and the pressurizing roll are brought into contact with each other to start the fixing.

9. The fixing device according to claim 8,
wherein the heating belt and the pressurizing roll are brought into contact with each other after a surface temperature T1 of the heating belt reaches 120° C. or higher, and the fixing is started after a surface temperature T2 of the heating belt reaches 130° C. or higher.

10. An image forming apparatus comprising:
an image holder;
a charging device that charges a surface of the image holder;
an electrostatic latent image forming device that forms an electrostatic latent image on the charged surface of the image holder;
a developing device that accommodates a developer containing a toner and develops the electrostatic latent image formed on the surface of the image holder with the developer to form a toner image;
a transfer device that transfers the toner image onto a surface of a recording medium; and
the fixing device according to claim 1, that fixes the toner image on the surface of the recording medium.

11. An image forming apparatus comprising:
an image holder;
a charging device that charges a surface of the image holder;
an electrostatic latent image forming device that forms an electrostatic latent image on the charged surface of the image holder;
a developing device that accommodates a developer containing a toner and develops the electrostatic latent image formed on the surface of the image holder with the developer to form a toner image;
a transfer device that transfers the toner image onto a surface of a recording medium; and
the fixing device according to claim 2, that fixes the toner image on the surface of the recording medium.

12. An image forming apparatus comprising:
an image holder;
a charging device that charges a surface of the image holder;
an electrostatic latent image forming device that forms an electrostatic latent image on the charged surface of the image holder;
a developing device that accommodates a developer containing a toner and develops the electrostatic latent image formed on the surface of the image holder with the developer to form a toner image;
a transfer device that transfers the toner image onto a surface of a recording medium; and
the fixing device according to claim 3, that fixes the toner image on the surface of the recording medium.

13. An image forming apparatus comprising:
an image holder;
a charging device that charges a surface of the image holder;
an electrostatic latent image forming device that forms an electrostatic latent image on the charged surface of the image holder;
a developing device that accommodates a developer containing a toner and develops the electrostatic latent image formed on the surface of the image holder with the developer to form a toner image;
a transfer device that transfers the toner image onto a surface of a recording medium; and
the fixing device according to claim 4, that fixes the toner image on the surface of the recording medium.

14. An image forming apparatus comprising:
an image holder;
a charging device that charges a surface of the image holder;
an electrostatic latent image forming device that forms an electrostatic latent image on the charged surface of the image holder;
a developing device that accommodates a developer containing a toner and develops the electrostatic latent image formed on the surface of the image holder with the developer to form a toner image;
a transfer device that transfers the toner image onto a surface of a recording medium; and
the fixing device according to claim 5, that fixes the toner image on the surface of the recording medium.

15. An image forming apparatus comprising:
an image holder;
a charging device that charges a surface of the image holder;
an electrostatic latent image forming device that forms an electrostatic latent image on the charged surface of the image holder;
a developing device that accommodates a developer containing a toner and develops the electrostatic latent image formed on the surface of the image holder with the developer to form a toner image;
a transfer device that transfers the toner image onto a surface of a recording medium; and
the fixing device according to claim 6, that fixes the toner image on the surface of the recording medium.

16. An image forming apparatus comprising:
an image holder;
a charging device that charges a surface of the image holder;
an electrostatic latent image forming device that forms an electrostatic latent image on the charged surface of the image holder;
a developing device that accommodates a developer containing a toner and develops the electrostatic latent image formed on the surface of the image holder with the developer to form a toner image;
a transfer device that transfers the toner image onto a surface of a recording medium; and
the fixing device according to claim 7, that fixes the toner image on the surface of the recording medium.

17. An image forming apparatus comprising:
an image holder;
a charging device that charges a surface of the image holder;
an electrostatic latent image forming device that forms an electrostatic latent image on the charged surface of the image holder;
a developing device that accommodates a developer containing a toner and develops the electrostatic latent image formed on the surface of the image holder with the developer to form a toner image;
a transfer device that transfers the toner image onto a surface of a recording medium; and
the fixing device according to claim 8, that fixes the toner image on the surface of the recording medium.

18. An image forming apparatus comprising:
an image holder;
a charging device that charges a surface of the image holder;
an electrostatic latent image forming device that forms an electrostatic latent image on the charged surface of the image holder;
a developing device that accommodates a developer containing a toner and develops the electrostatic latent image formed on the surface of the image holder with the developer to form a toner image;
a transfer device that transfers the toner image onto a surface of a recording medium; and
the fixing device according to claim 9, that fixes the toner image on the surface of the recording medium.
